(19) United States
(12) Patent Application Publication
(10) Pub. No.: US 2026/0161301 A1
(43) Pub. Date: Jun. 11, 2026

(54) DETERMINING ERASE/PROGRAM CYCLE STATUS IN A MEMORY SYSTEM

(71) Applicant: Yangtze Memory Technologies Co., Ltd., Wuhan (CN)

(72) Inventors: Lingling MA, Wuhan (CN); Lu GUO, Wuhan (CN); Xingwei TANG, Wuhan (CN)

(21) Appl. No.: 19/023,672

(22) Filed: Jan. 16, 2025

(30) Foreign Application Priority Data
Dec. 6, 2024 (CN) 202411797625.5

(51) Int. Cl. G06F 3/06

(52) U.S. Cl. CPC G06F 3/0616; G06F 3/0656; G06F 3/0679

(57) ABSTRACT

Methods, devices, and systems for managing memory devices are provided. In one aspect, a memory system can include a memory device including one or more memory pages, and a memory controller coupled to the memory device. The memory controller is configured to perform operations including obtaining a read window corresponding to the one or more memory pages, and determining, based on the read window, an erase/program (E/P) cycle status of the one or more memory pages.

### CROSS-REFERENCE TO RELATED APPLICATIONS

This application claims priority to Chinese Patent Application No. 202411797625.5, filed on December 06, 2024, which is hereby incorporated by reference in its entirety.

### TECHNICAL FIELD

The present disclosure generally relates to memory devices and memory systems, and in particular, to determining erase/program (E/P) cycle status in memory systems.

### BACKGROUND

Flash memory is a low-cost, high-density, nonvolatile solid-state storage medium that can be electrically erased and reprogrammed. Flash memory includes NOR flash memory and NAND flash memory. Various operations can be performed by a flash memory, for example, program (write) or read operations. Operations performed by a flash memory can affect temperature of the flash memory.

### SUMMARY

The present disclosure involves methods, apparatuses, and systems for managing temperature in a memory system. In one example, a memory system includes a memory device including one or more memory pages, and a memory controller coupled to the memory device. The memory controller is configured to perform operations including obtaining a read window corresponding to the one or more memory pages, and determining, based on the read window, an erase/program (E/P) cycle status of the one or more memory pages.

In some implementations, obtaining the read window includes sending one or more commands to obtain the read window to the memory device, and obtaining the read window based on one or more responses to the one or more commands from the memory device. The one or more commands include an address of the one or more memory pages.

In some implementations, the E/P cycle status is determined based on a pre-determined relation between an E/P cycle and the read window, where the read window decreases with an increase of the E/P cycle.

In some implementations, the pre-determined relation is stored in a buffer of the memory controller.

In some implementations, the E/P cycle status includes a ratio of a quantity of undergone E/P cycles of a first memory block to an expected maximum quantity of E/P cycles of the first memory block. The first memory block includes the one or more memory pages.

In some implementations, the operations further include, in response to determining that the ratio is larger than a threshold, moving data from the first memory block to a second memory block.

In some implementations, the memory controller is configured to perform the operations in response to detecting a failure in the memory device.

In some implementations, the memory controller is configured to perform the operations in response to receiving a request to obtain health information of the memory device from a host. The operations further include sending the health information including the E/P cycle status to the host.

Another aspect of the present disclosure features a memory controller. The memory controller includes one or more processors and an interface. The memory controller is configured to send, through the interface to a memory device coupled to the memory controller, one or more commands to obtain a read window corresponding to one or more memory pages of the memory device, and determine, by the one or more processors based on the read window, an erase/program (E/P) cycle status of the one or more memory pages.

In some implementations, the memory controller is configured to obtain the read window by receiving one or more responses to the one or commands from the memory device.

In some implementations, the E/P cycle status is determined based on a pre-determined relation between an E/P cycle and the read window, where the read window decreases with an increase of the E/P cycle.

In some implementations, the memory controller includes a buffer. The pre-determined relation is stored in the buffer.

In some implementations, the E/P cycle status includes a ratio of a quantity of undergone E/P cycles of a first memory block to an expected maximum quantity of E/P cycles of the first memory block. The first memory block includes the one or more memory pages.

In some implementations, the memory controller is configured to, in response to determining that the ratio is larger than a threshold, move data from the first memory block to a second memory block.

In some implementations, the memory controller is configured to determine the E/P cycle status in response to detecting a failure in the memory device.

In some implementations, the memory controller is configured to determine the E/P cycle status in response to receiving, from a host, a request to obtain health information of the memory device, and send the health information including the E/P cycle status to the host.

Another aspect of the present disclosure features a method of operating a memory system. The method includes obtaining a read window corresponding to one or more memory pages of a memory device of the memory system, and determining, based on the read window, an erase/program (E/P) cycle status of the one or more memory pages.

In some implementations, the method includes sending one or more commands to obtain the read window to the memory device, and obtaining the read window based on one or more responses to the one or more commands from the memory device. The one or more commands include an address of the one or more memory pages.

In some implementations, the E/P cycle status is determined based on a pre-determined relation between an E/P cycle and the read window, where the read window decreases with an increase of the E/P cycle.

In some implementations, the E/P cycle status includes a ratio of a quantity of undergone E/P cycles of a first memory block to an expected maximum quantity of E/P cycles of the first memory block. The first memory block includes the one or more memory pages.

Another aspect of the present disclosure features a non-transitory, computer readable medium. The non-transitory, computer readable medium stores one or more instructions executable by a memory system to perform operations including obtaining a read window corresponding to the one or more memory pages, and determining, based on the read window, an erase/program (E/P) cycle status of the one or more memory pages.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system having a memory device, according to some aspects of the present disclosure.

FIGS. 2A-2B illustrate example storage products, according to some aspects of the present disclosure.

FIG. 3 illustrates an example of a schematic diagram of a memory device including peripheral circuits, according to some aspects of the present disclosure.

FIG. 4 illustrates some example peripheral circuits, according to some aspects of the present disclosure.

FIG. 5 illustrates an example of threshold voltage distributions of memory cells in a memory page, according to some aspects of the present disclosure.

FIG. 6 illustrates performances of a memory device as E/P cycle increases, according to some aspects of the present disclosure.

FIG. 7 illustrates a swimlane diagram of an example process of determining E/P cycle status, according to some aspects of the present disclosure.

FIG. 8 illustrates a swimlane diagram of an example process of determining E/P cycle status, according to some aspects of the present disclosure.

Like reference numbers and designations in the various drawings indicate like elements.

### DETAILED DESCRIPTION

This specification relates to memory devices, memory systems, and methods for determining erase/program (E/P) cycle status in a memory system (e.g., a NAND memory system). With an increase of E/P cycles that a memory device has undergone, the performance of the memory device may change. For example, a program time needed to program a memory page may decrease with the increase of E/P cycles. For another example, a read window (e.g., Esum) corresponding to a memory page that is programmed during the current E/P cycle may decrease with the increase of E/P cycles.

In some cases, a memory controller can determine an E/P cycle status of the memory device by measuring program time. For example, the memory controller can measure the program time needed to program one or more memory pages in a target memory block, and determine the E/P cycle status of the target memory block by mapping the program time to an E/P cycle status based on a pre-determined relation between program time and E/P cycle. However, measuring program time may require erasing the target memory block and writing new data, which adds to the E/P cycle of the target memory block. Further, erasing the target memory block may disrupt an existing status (e.g., a failed status) of the memory device, which may increase the difficulty of failure analysis.

The present disclosure provides techniques to determine an E/P cycle status of the memory device by measuring a read window. In some implementations, the memory controller can send one or more commands to the memory device to obtain a read window of one or more memory pages in a target memory block. By mapping the read window to an E/P cycle status based on a pre-determined relation between a read window and an E/P cycle, the memory controller can determine the E/P cycle status of the target memory block.

The described techniques can achieve one or more technical effects. For example, read window decreases with the increase of E/P cycles in a more significant way than the decrease of program time. As such, the memory controller can determine E/P cycle status more accurately based on a read window, compared to determining E/P cycle status based on program time. For another example, measuring read window does not require erasing data in the target memory block, which can keep the existing status of the memory device to facilitate failure analysis. Further, the described techniques do not require hardware or software changes in the memory system, which is cost-effective. In some implementations, additional or different technical effects can be achieved.

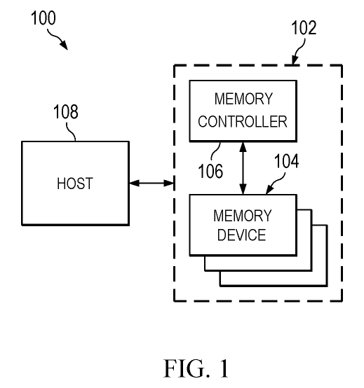

FIG. 1 illustrates a block diagram of an example system 100 having a memory device, according to some aspects of the present disclosure. The system 100 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 1, the system 100 can include a host 108 and a memory system 102 having one or more memory devices 104 and a memory controller 106. The host 108 can include one or more processors of an electronic device. The processor can be a central processing unit (CPU), or a system-on-chip (SoC), such as an application processor (AP). The host 108 can be configured to send or receive data and commands to or from the memory systems 102.

The memory device 104 can be any memory device disclosed in the present disclosure, such as a NAND Flash memory device. It is noted that the NAND Flash is only one example of memory device for illustrative purposes. It can include any suitable solid-state, non-volatile memory, e.g., NOR Flash, Ferroelectric RAM (FeRAM), Phase-change memory (PCM), Magne-to-resistive random- access memory (MRAM), Spin-transfer torque magnetic random-access memory (STT-RAM), or Resistive random-access memory (RRAM), etc. In some implementations, memory device 104 includes a three-dimensional (3D) NAND Flash memory device.

The memory controller 106 can be implemented by microprocessors, microcontrollers (a.k.a. microcontroller units (MCUs)), digital signal processors (DSPs), application-specific integrated circuits (ASICs), field-programmable gate arrays (FPGAs), programmable logic devices (PLDs), state machines, gated logic, discrete hardware circuits, and other suitable hardware, firmware, and/or software configured to perform the various functions described below in detail.

The memory controller 106 is coupled to the memory device 104 and to the host 108, and is configured to control the memory device 104, according to some implementations. The memory controller 106 can manage the data stored in the memory device 104 and can communicate with the host 108. In some implementations, the memory controller 106 is designed for operating in a low duty-cycle environment, such as secure digital (SD) cards, compact Flash (CF) cards, universal serial bus (USB) Flash drives, or other media for use in electronic devices, such as personal computers, digital cameras, mobile phones, etc. In some implementations, memory controller 106 is designed for operating in a high duty-cycle environment solid state drives (SSDs) or embedded multi-media-cards (eMMCs) used as data storage for mobile devices, such as smartphones, tablets, laptop computers, etc., and enterprise storage arrays. The memory controller 106 can be configured to control operations of the memory device 104, such as read, erase, and program operations. The memory controller 106 can also be configured to manage various functions with respect to the data stored or to be stored in the memory device 104 including, but not limited to bad-block management, garbage collection, logical-to-physical address conversion, logical-to-physical mapping management, wear leveling, etc. In some implementations, the memory controller 106 is further configured to process error correction codes (ECCs) with respect to the data read from or written to the memory device 104. Any other suitable functions can be performed by the memory controller 106 as well, for example, formatting the memory device 104.

The memory controller 106 can communicate with an external device (e.g., the host 108) according to a particular communication protocol. For example, the memory controller 106 can communicate with the external device by one or more interfaces by at least one of various interface protocols, such as a USB protocol, an MMC protocol, a peripheral component interconnection (PCI) protocol, a PCI- express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc. The memory controller 106 is configured to receive and transmit a command to and from the host 108, and execute or perform multiple functions and operations provided in the present disclosure, which will be described later.

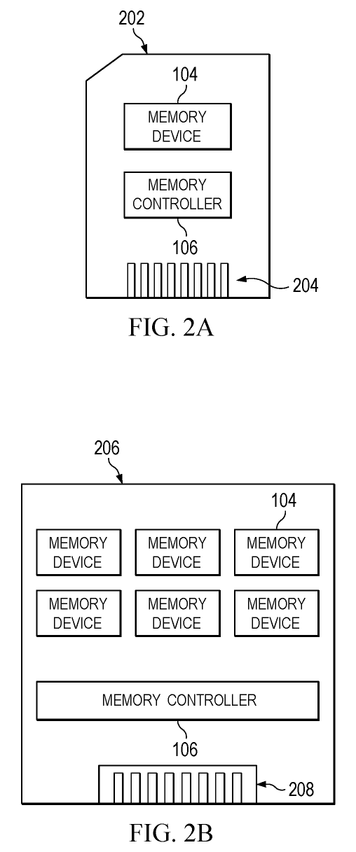

The memory controller 106 and the one or more memory devices 104 can be integrated into various types of storage devices. For example, the memory controller 106 and the one or more memory devices 104 can be packaged in a universal Flash storage (UFS) package or an eMMC package. In one example as shown in FIG. 2A, the memory controller 106 and a single memory device 104 can be integrated into a memory card 202. The memory card 202 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. The memory card 202 can further include a memory card connector 204 coupling the memory card 202 with a host (e.g., host 108 in FIG. 1). In another example as shown in FIG. 2B, the memory controller 106 and multiple memory devices 104 can be integrated into an SSD 206. The SSD 206 can further include an SSD connector 208 that couples the SSD 206 with a host (e.g., host 108 in FIG. 1). In some implementations, the storage capacity and/or the operation speed of the SSD 206 is greater than those of the memory card 202.

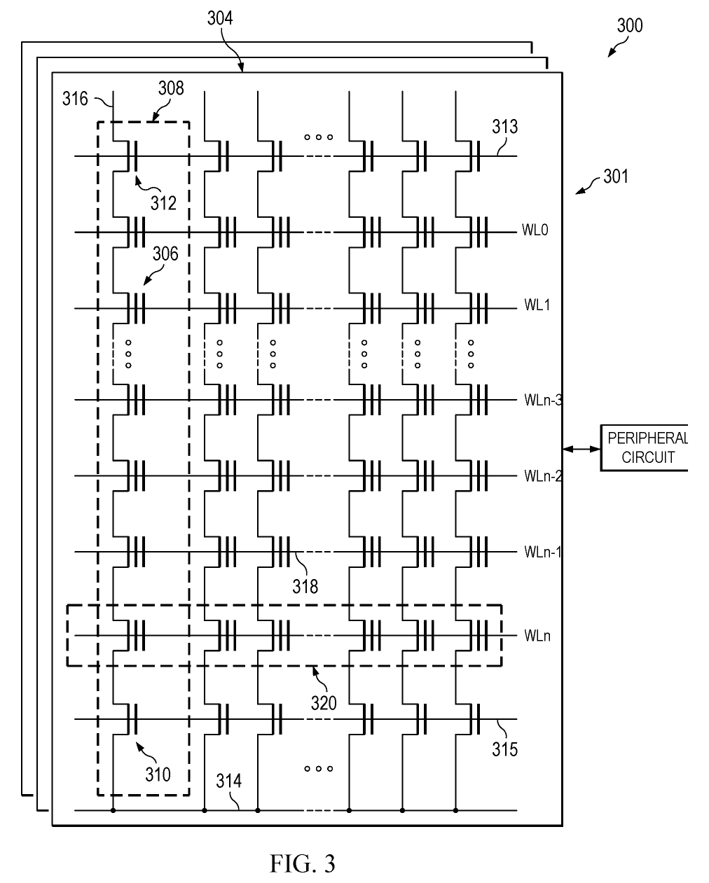

FIG. 3 illustrates an example of a schematic diagram of a memory device 300 including peripheral circuits, according to some aspects of the present disclosure. The memory device 300 can include a memory cell array 301 and peripheral circuits 302 coupled to the memory cell array 301. The memory cell array 301 can be a NAND Flash memory cell array in which memory cells 306 are provided in the form of an array of memory strings 308 each extending vertically above a substrate (not shown in FIG. 3). In some implementations, each memory string 308 includes a plurality of memory cells 306 coupled in series and stacked vertically. Each memory cell 306 can hold a continuous, analog value, such as an electrical voltage or charge that depends on the number of electrons trapped within a storage layer of the memory cell 306. The logic state (i.e., data) of each memory cell 306 in a memory block 304 can be determined based on the threshold voltage Vth of the memory cell 306. Each memory cell 306 can be a floating gate type memory cell including a floating-gate transistor, or a charge trap type memory cell including a charge-trap transistor.

In some implementations, each memory cell 306 is a single-level cell (SLC) with two possible memory states that can store one bit of data. For example, the first memory state “0” can correspond to a first range of voltages, and the second memory state “1” can correspond to a second range of voltages. In some implementations, each memory cell 306 is a multi-level cell (MLC) that is capable of storing more than one bit of data in more than two memory states. For example, the MLC can store two bits per cell, three bits per cell (also known as triple-level cell (TLC)), or four bits per cell (also known as a quad-level cell (QLC)). Each MLC can be programmed to support a range of possible nominal storage values. In one example, if each MLC stores two bits of data, then the MLC can be programmed to one of three possible programming levels from an erased state by writing one of three possible nominal storage values to the cell. A fourth nominal storage value can be used for the erased state.

As shown in FIG. 3, each memory string 308 can include a source select gate (SSG) 310 at its source end and a drain select gate (DSG) 312 at its drain end. The SSG 310 and the DSG 312 can be configured to activate selected memory strings 308 (columns of the array) during read and program operations. In some implementations, the sources of memory strings 308 in the same memory block 304 are coupled through a same source line (SL) 314, e.g., a common SL. In other words, memory strings 308 in the same memory block 304 have an array common source (ACS), according to some implementations. The DSG 312 of each memory string 308 is coupled to a respective bit line 316 from which data can be read or written via an output bus (not shown), according to some implementations. In some implementations, each memory string 308 is configured to be selected or deselected by applying a select voltage (e.g., above the threshold voltage of the transistor having the DSG 312) or a deselect voltage (e.g., 0 V) to the respective DSG 312 through one or more DSG lines 313, and/or by applying a select voltage (e.g., above the threshold voltage of the transistor having the SSG 310) or a deselect voltage (e.g., 0 V) to the respective SSG 310 through one or more SSG lines 315.

As shown in FIG. 3, memory strings 308 can be organized into multiple memory blocks 304, each of which can have a common SL 314 coupled to the ACS. In some implementations, each memory block 304 can serve as a basic data unit for erase operations, such that memory cells 306 on the same memory block 304 are erased at the same time. To erase memory cells 306 in a selected memory block 304, the SL 314 coupled to the selected memory block 304 and unselected memory blocks in the same plane can be biased with an erase voltage. For example, the erase voltage can be a high positive voltage (e.g., 20 V or more). In some implementations, an erase operation can be performed at a half-block level, a quarter-block level, or a level having any suitable number of memory blocks or fractions of a memory block.

The memory cells 306 of adjacent memory strings 308 can be coupled through word lines 318. The word line 318 can select which row of memory cells 306 is affected by read and program operations. Each word line 318 can include a gate line coupled to a plurality of control gates (gate electrodes) of a plurality of memory cells 306. Example word lines shown in FIG. 3 are between one or more DSG lines 313 and one or more SSG lines 315.

In some implementations, the memory cells 306 of adjacent strings 308 can be coupled through word lines 318 to form one or more memory pages 320 (e.g., physical pages). The word line 318 can select which row of memory cells 306 is affected by read and program operations. In some implementations where memory cells 306 are SLCs, a memory page 320 of memory cells 306 can store one logic page of data, and therefore corresponds to one logic page. In some implementations where memory cells 306 are MLCs, a memory page 320 of memory cells 306 can store two logic pages of data, and therefore corresponds to two logic pages. In some implementations where memory cells 306 are TLCs, a memory page 320 of memory cells 306 can store three logic pages of data, and therefore corresponds to three logic pages. In some implementations where memory cells 306 are QLCs, a memory page 320 of memory cells 306 can store four logic pages of data, and therefore corresponds to four logic pages.

The size of one memory page 320 in bits is associated with the number of strings 308 coupled by word line 318 in a block. Each word line 318 can include a gate line coupled to a plurality of control gates (gate electrodes) of a plurality of memory cells 306 in the respective memory page 320. Example word lines shown in FIG. 3 include WL0, WL1, …, WLn-2, WLn-1, and WLn that are between DSG line 313 and SSG line 315. In some implementations, the word lines can further include dummy word lines coupled to dummy memory cells.

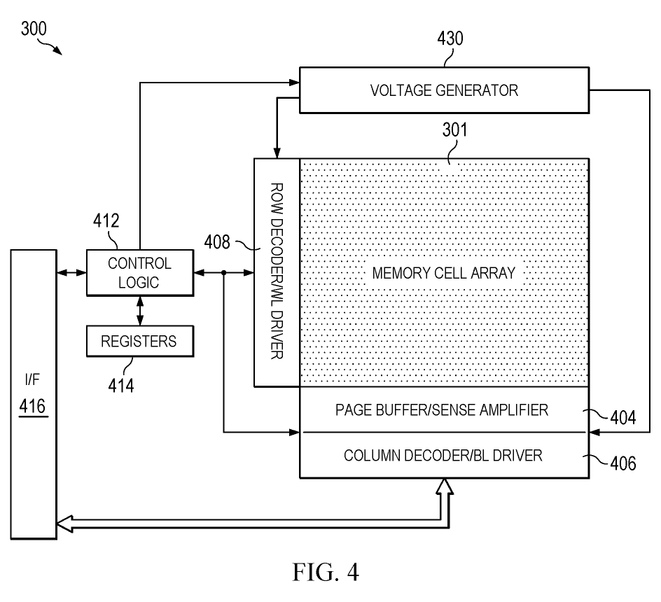

FIG. 4 illustrates some example peripheral circuits 302, according to some aspects of the present disclosure. The peripheral circuits 302 can be coupled to the memory cell array 301 through bit lines 316, word lines 318, SLs 314, SSG lines 315, and DSG lines 313. The peripheral circuits 302 can include any suitable analog, digital, and mixed-signal circuits for facilitating the operations of the memory cell array 301 by applying and sensing voltage signals and/or current signals to and from each target memory cell 306 through bit lines 316, word lines 318, SLs 314, SSG lines 315, and DSG lines 313. The peripheral circuits 302 can include various types of peripheral circuits formed using metal-oxide-semiconductor (MOS) technologies. The example peripheral circuits 302 include a page buffer/sense amplifier 404, a column decoder/bit line driver 406, a row decoder/word line driver 408, a voltage generator 410, control logic 412, registers 414, an interface 416, and a data bus. In some examples, additional peripheral circuits not shown in FIG. 4 may be included as well.

The page buffer/sense amplifier 404 can be configured to read and program (write) data from and to memory cell array 301 according to the control signals from control logic 412. In an example, the page buffer/sense amplifier 404 may store one page of program data (write data) to be programmed into one memory page 320 of the memory cell array 301. In another example, the page buffer/sense amplifier 404 may perform program verify operations to ensure that the data have been properly programmed into memory cells 306 coupled to selected word lines 318. In still another example, the page buffer/sense amplifier 404 may also sense the low power signals from the bit line 316 that represents a data bit stored in memory cell 306, and amplify the small voltage swing to recognizable logic levels in a read operation. The column decoder/bit line driver 406 can be configured to be controlled by the control logic 412 and select one or more memory strings 308 by applying bit line voltages generated from the voltage generator 410.

The row decoder/word line driver 408 can be configured to be controlled by the control logic 412 and select/deselect memory blocks 304 of the memory cell array 301 and select/deselect word lines 318 of the memory block 304. The row decoder/word line driver 408 can be further configured to drive word lines 318 using word line voltages generated from the voltage generator 410. In some implementations, the row decoder/word line driver 408 can also select/deselect and drive SSG lines 315 and DSG lines 313. As described below in detail, the row decoder/word line driver 408 is configured to apply a program voltage to selected word line 318 in a program operation on memory cell 306 coupled to selected word line 318.

The voltage generator 410 can be configured to be controlled by the control logic 412 and generate the word line voltages (e.g., read reference voltage, program voltage, pass voltage, local voltage, verify voltage, etc.), bit line voltages, and source line voltages to be supplied to the memory cell array 301.

The control logic 412 can be coupled to each peripheral circuit described above and configured to control operations of each peripheral circuit. The registers 414 can be coupled to the control logic 412 and include status registers, command registers, and address registers for storing status information, command operation codes (OP codes), and command addresses for controlling the operations of each peripheral circuit.

The interface 416 can be coupled to the control logic 412 and act as a control buffer to buffer and relay control commands received from a host (not shown) to the control logic 412 and status information received from the control logic 412 to the host. The interface 416 can also be coupled to the column decoder/bit line driver 406 via a data bus, and act as a data input/output (I/O) interface and a data buffer to buffer and relay data to and from the memory cell array 301.

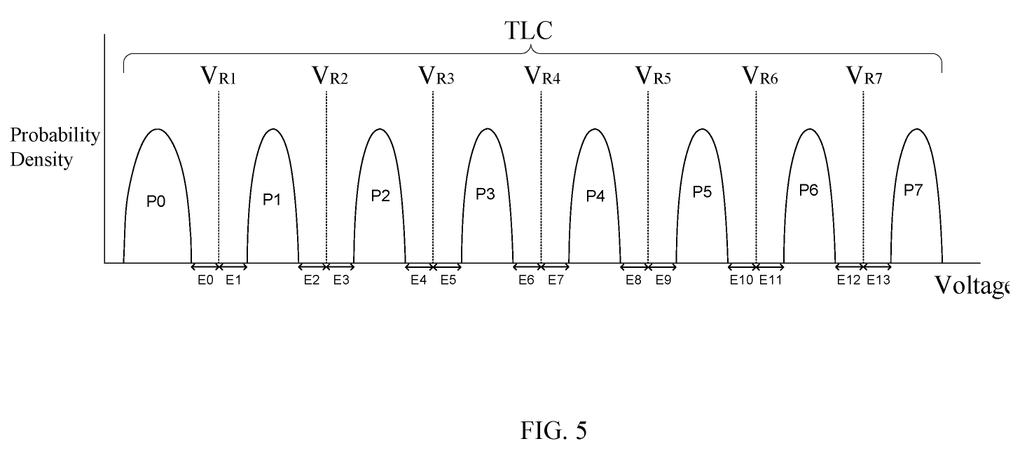

FIG. 5 illustrates an example of threshold voltage distributions of memory cells (e.g., memory cells 306 of FIG. 3) in a memory page (e.g., memory page 320 of FIG. 3), according to some aspects of the present disclosure.

Memory cells in a memory page can be configured to be set as one of a plurality of states, including an erased state and one or more programmed states. Each state corresponds to a range of threshold voltages Vₜₕ, where the Vₜₕ distribution of each state can be represented by a probability density. In some implementations, each state can be programmed by using an incremental step pulse programming (ISPP) scheme, where the program voltage applied to the selected word line can be incrementally increased by adding a step pulse.

During a read operation, the state of a memory cell can be determined by comparing the threshold voltage (Vₜₕ) of the memory cell with one or more read reference voltages VR (e.g., VR1, VR2, …). A read reference voltage VR can be within a voltage interval between Vₜₕ distributions of two adjacent states, i.e., between a highest possible Vₜₕ (aka, an upper tail of Vₜₕ distribution) of a lower state and a lowest possible Vₜₕ (aka, a lower tail of Vₜₕ distribution) of a higher state.

As an example shown in FIG. 5, memory cells in a memory page of a TLC memory device can be configured to be set as one of eight states P0-P7, where P0 is the erased state and P1-P7 are programmed states. From the state P0 to the state P7, Vₜₕ of the memory cells increases. For example, the eight states of the memory cells can be programmed, from the erased state P0 to the programmed state P1 having a lower threshold voltage, and then to programmed state P2, P3, … P7 having higher threshold voltages respectively. In the TLC memory device, by applying the read reference voltages VR1-VR7 to a selected word line (e.g., word line 318 of FIG. 3), the memory device can determine a range of Vₜₕ of a target memory cell in the corresponding memory page. As an example, to verify if the target memory cell is at state P0, the memory device can apply the read reference voltage VR1 to the word line. If the target memory cell is at state P0, Vₜₕ of the target memory cell is lower than VR1, the target memory cell is therefore switched on to form a conductive path in the channel. If the target memory cell is at any one of the states P1-P7, Vₜₕ of the target memory cell is higher than VR1, the target memory cell is therefore switched off. By measuring or sensing the current through the target memory cell or sensing a voltage drop at the corresponding bit line (e.g., bit line 316 of FIG. 3), the memory device can determine Vₜₕ or the state of the target memory cell.

In some implementations, a read window can be used to characterize the voltage intervals between the Vₜₕ distributions of adjacent states. In some implementations, a read window can include one or more read margins, each read margin indicating a tolerance interval of a threshold voltage with respect to a read reference voltage of a state of a memory cell. Generally, a larger read margin indicates a better performance (e.g., in terms of reliability or accuracy of data read) of a memory cell compared to a smaller read margin. For example, a first read margin (E0) may refer to a voltage interval between an upper tail of the Vₜₕ distribution of the state P0 and a read reference voltage VR1, which can be used to read data from memory cells in the state P0; a second read margin (E1) may refer to a voltage interval between the read reference voltage VR1 and a lower tail of the Vₜₕ distribution of the state P1, which can be used to read data from memory cells in the state P1; a third read margin (E2) may refer to a voltage interval between an upper tail of Vₜₕ distribution of the state P1 and a read reference voltage VR2, which can be used to read data from memory cells in the state P1, and so on. As an example shown in FIG. 5, for a memory page comprising TLC memory cells, a read window corresponding to the memory page may be represented by Esum that includes a total of 13 read margins: E1, E2, . . . , E13, which may be written as Esum=E1+ E2+. . . +E13. In some implementations, a larger Esum value indicates a better performance (e.g., in terms of reliability or accuracy of data read) of a memory cell compared to a smaller Esum value. In some other examples, a read window can represented in another form by one or more read margins and/or other metrics or measures of the Vₜₕ distribution of the memory device, for example, as a variant or alternative of Esum. In some implementations, a read window corresponding to a memory page comprising one or more MLC/QLC/penta-level cells (PLC) memory cells can be determined following similar approaches.

In some implementations, in response to receiving one or more commands from the memory controller that indicate to obtain the read window (e.g., Esum) corresponding to a target memory page, the memory device can sense memory cells in the target memory page by applying a set of read reference voltages (e.g., including VR1, VR2, VR3, …), calculate the read window corresponding to the target memory page, and send the read window to the memory controller. In some implementations, the memory device can send Vₜₕ distributions of the plurality of states to the memory controller, and the memory controller can calculate the read window based on the Vₜₕ distributions.

In some implementations, the memory device can send the read window (e.g., Esum) corresponding to the target memory page to the memory controller, without outputting data from the target memory page to the memory controller.

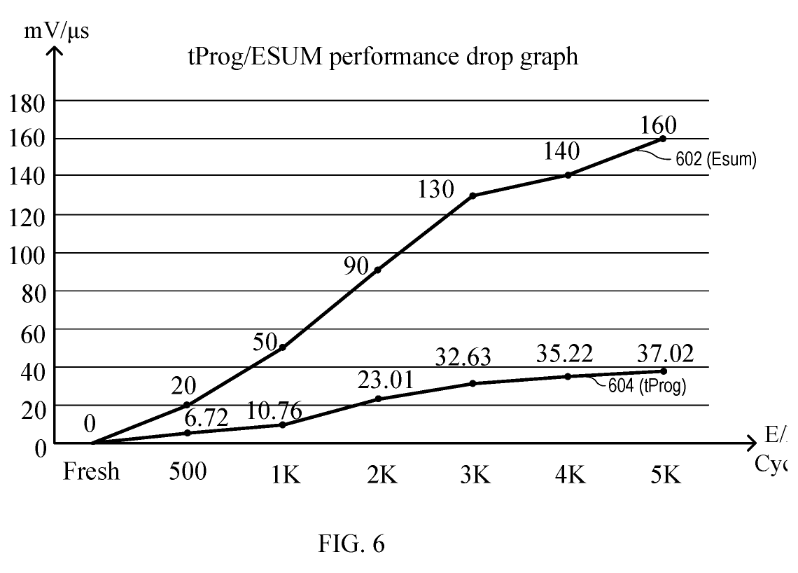

FIG. 6 illustrates performances of a memory device (e.g., the memory device 104 of FIGS. 1-2B, or the memory device 300 of FIGS. 3-4) as E/P cycle increases, according to some aspects of the present disclosure.

In a NAND memory device, typically data stored in memory cells need to be erased before new data can be stored. For example, the memory device needs to perform an erase operation on a memory block, before performing a next program operation on memory pages of the memory block, which is generally referred to as an erase/program (E/P) cycle of the memory block. In some cases, a memory block has an expected life span characterized by an expected maximum quantity of E/P cycles (e.g., 5000 E/P cycles, or another suitable quantity of E/P cycles). If the quantity of E/P cycles that the memory block has undergone is less than a first threshold (e.g., 500 or 1000 E/P cycles, or 10% of the expected maximum quantity of E/P cycles), the memory block is deemed to be in fresh cycles, or in a beginning-of-life (BOE) state. If the quantity of E/P cycles that the memory block has undergone is greater than a second threshold (e.g., e.g., 4000 or 4500 E/P cycles, or 90% of the expected maximum quantity of E/P cycles), the memory block is deemed to be in late cycles, or in an end-of-life (EOL) state.

Performances of the memory device may change with an increase of E/P cycles. For example, curve 602 illustrates a change (e.g., a performance drop) of a read window (in term of Esum in this example) with an increase of E/P cycles. As a memory block progresses to a later E/P cycle, a read window of a memory page of the memory block that is programmed during the current E/P cycle may decrease. As one example, using the Esum value of a memory page programmed during the first cycle as a reference, the performance drop in terms of Esum increases with respect to the reference can be, for example, the difference between the Esum values at the two time instances. As shown in FIG. 6, the Esum performance drop increases as the number of E/P cycles increases. For example, the Esum value of a memory page programmed during the 5000^{th} E/P cycle drops more than the Esum of the memory page programmed during the 5000^{th} E/P cycle.

On the other hand, curve 604 illustrates the change of program time (t_{Prog}) with the increase of E/P cycles. Program time refers to the time needed to program memory cells in a memory page to a target state among a plurality of states (e.g., P0-P7 for TLC, or P0-P15 for QLC). As a memory block progresses to a later E/P cycle, a program time to program a memory page to a target state in the memory block may increase. As one example, using the t_{Prog} to program a memory page during the first cycle as a reference, the performance drop in terms of t_{Prog} can be, for example, the difference between the t_{Prog} values at the two time instances. As shown in FIG. 6, the t_{Prog} performance drop increases as the number of E/P cycles increases. For example, the t_{Prog} performance drop during the 1000^{th} E/P cycle may be shorter than the t_{Prog} performance drop during the 5000^{th} E/P cycle.

As shown, there are a correlation between the read window (e.g., Esum) and the number of E/P cycles, and a correlation between the program time (t_{Prog}) and the number of E/P cycles. ISI, by measuring a certain performance of the memory device (e.g., Esum or t_{Prog} of one or more memory pages), the memory controller can determine an E/P cycle status of the memory device (e.g., undergone E/P cycle of the memory block comprising the one or more memory pages). Also shown in FIG. 6 is that Esum performance decreases with an increase of E/P cycles in a more significant way than the decrease of t_{Prog}performance. Further, measuring t_{Prog} may require erasing the memory block and writing new data in memory pages of the memory block, which may disrupt an existing status of the memory device. As such, in some implementations, techniques to determine E/P cycle status based on Esum can be advantageous.

In some implementations, the memory controller can obtain a read window (e.g., Esum) corresponding to one or more memory pages, and determine an E/P cycle status of the one or more memory pages (e.g., E/P cycles status of the memory block comprising the one or more memory pages) based on the Esum and a pre-determined relation between Esum and E/P cycles. The pre-determined relation between Esum and E/P cycles can be obtained based on empirical data or test data, and stored in a storage medium (e.g., a buffer) of the memory controller. For example, the pre-determined relation can be a fitted formula of E/P cycle varying with Esum, where E/P cycle increases with a decrease of Esum. For another example, the pre-determined relation can be in the form of a mapping table, where multiple ranges of Esum are each mapped to a corresponding E/P cycle, or mapped to a corresponding range of E/P cycle. In some other examples, the pre-determined relation can be determined based on machine learning techniques.

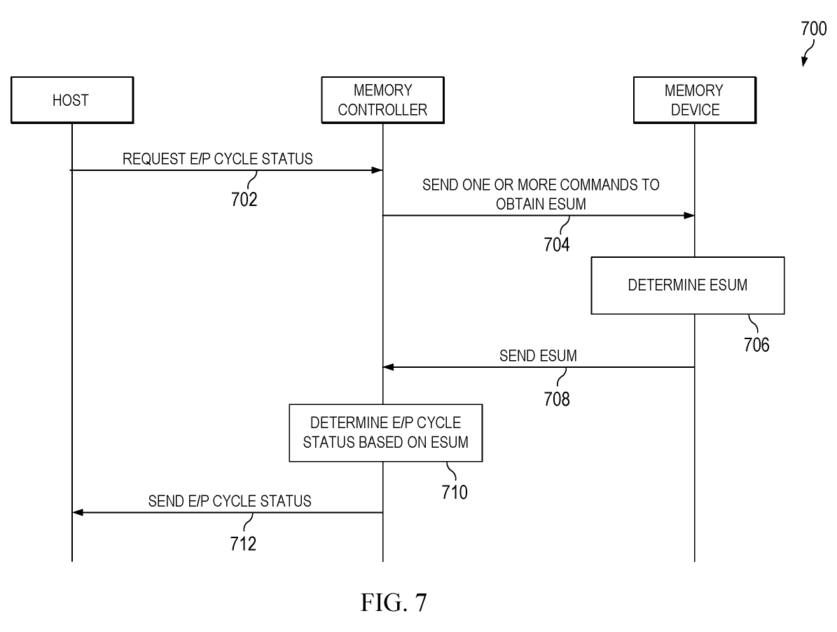

FIG. 7 illustrates a swimlane diagram of an example process 700 of determining E/P cycle status, according to some aspects of the present disclosure. Process 700 can be performed by any suitable device or system as described herein, for example, according to the example techniques described with respect to FIGS. 1-6. For example, process 700 can be performed by a memory system, such as the memory system 102 of FIG. 1, which includes a memory controller 106 and a memory device 104. In some implementations, the memory device can include a memory cell array (e.g., memory cell array 301 of FIGS. 3-4) including memory pages (e.g., memory pages 320 of FIG. 3), and peripheral circuits (e.g., peripheral circuits 302 of FIG. 3).

The operations shown in process 700 may not be exhaustive and that other operations can be performed as well before, after, or in between any of the illustrated operations. Further, some of the operations may be performed simultaneously, or in a different order than shown in FIG. 7. In some implementations, some of the operations may be performed by or one or more components of a device or a system, such as, a memory controller, or a peripheral circuit of the memory device.

At 702, a host (e.g., host 108 of FIG. 1) sends a request to obtain E/P cycle status of a target memory block, or one or more target memory blocks, of the memory device. In some implementations, the request can be a request to obtain health information (e.g., Self-Monitoring, Analysis and Reporting Technology (SMART) information) of the memory device. The health information can include various indicators, such as current temperature, power cycle count, power-on hours, minimum E/P cycle count, and maximum E/P cycle count, that may have an impact on the reliability of the memory device.

In some implementations, the host can be a test platform (e.g., a Magnum platform). The memory system can be connected to the test platform, where the test platform can send a request to obtain E/P cycle status of one or more memory blocks of the memory device.

At 704, in response to receiving the request from the host, the memory controller sends to the memory device one or more commands to obtain a read window (e.g., Esum) corresponding to one or more memory pages. The one or more commands include an address of the one or more memory pages. In the following, Esum is used as an example metric of the read window for illustration. Other metrics of a read window can be used and the process 700 can be performed accordingly. To determine an E/P cycle status of a target memory block, the memory controller sends one or more commands to obtain Esum corresponding to at least one programmed memory page of the target memory block. In some implementations, the memory controller sends one or more commands to obtain an overall Esum corresponding to multiple memory pages of the target memory block. For example, the memory pages in the target memory block can be grouped according to word line positions. The one or more commands can obtain Esum corresponding to one memory page in each group.

In some implementations, an erase operation can be performed at a half-block level, a quarter-block level, or a suitable fraction of a memory block. That is, the E/P cycle status of different fractions of a memory block may be different. In such case, to determine an E/P cycle status of a specific fraction of a memory block, the memory controller can send one or more commands to obtain Esum corresponding to at least one programmed memory page in the specific fraction of the memory block.

At 706, in response to receiving the one or commands from the memory controller, the memory device performs sensing on memory cells in the one or more memory pages and obtains Esum corresponding to the one or more memory pages. In some implementations, the memory device can apply a set of read reference voltages to a selected word line to determine threshold voltage distributions of memory cells in each state. The memory device can determine Esum corresponding to a memory page based on the threshold voltage distributions of memory cells in the memory page, for example, according to the description with respect to FIG. 5 or in another manner. In some implementations, the read window can be represented by other metrics which can be determined by the memory controller accordingly.

At 708, the memory device sends Esum corresponding to the one or more memory pages to the memory controller. In some implementations, the memory device sends Esum to the memory controller, without sending data from the one or more memory pages to the memory controller. In some implementations, the memory device sends one or more responses (e.g., including threshold voltage distributions of each of a plurality of states) corresponding to the one or more commands sent by the memory controller at 704, and the memory controller can obtain the read window based on the one or more responses.

At 710, the memory controller determines an E/P cycle status of the target memory block based on Esum corresponding to the one or more memory pages in the target memory block. In some implementations, the memory controller determines the E/P cycle status of the target memory block by mapping the obtained Esum to an E/P cycle status according to a pre-determined relation between Esum and E/P cycles.

At 712, the memory controller sends the E/P cycle status to the host. In some implementations, the E/P cycle status can be included in the health information of the memory device requested by the host at 702. In some implementations, the E/P cycle status can include a quantity of E/P cycles that the target memory block has undergone. In some implementations, the E/P cycle status can include a ratio of a quantity of undergone E/P cycles to an expected maximum quantity of E/P cycles of the target memory block.

In some implementations, the memory controller can determine an E/P cycle status of a target memory block by performing operations 704-710 in response to detecting a failure (e.g., a read failure, a program failure, or an erase failure) in the target memory block. By determining the E/P cycle status of the failed memory block, the memory controller or the host can perform a failure analysis. For example, if the failed memory block has undergone a large quantity of E/P cycles (e.g., approaching an EOL state), the failure can be attributed to the factor that the failed memory block has reached its expected life span. If the failed memory block is still in early E/P cycles (e.g., in a BOL state), the memory controller or the host can rule out the factor that the failed memory block has reached its expected life span, and continue to analyze other factors.

In some implementations, by determining the E/P cycle status of one or more memory blocks, the memory controller can instruct the memory device to move data from a first memory block (e.g., a memory block in EOL state) to a second memory block (e.g., a memory block in BOL state), to achieve wear leveling of the memory device.

In some implementations, the host can be connected to and configured to control a plurality of memory systems. For example, in a data center or a cloud storage setting, a central server or a control center can be configured to manage data storage across a plurality of memory systems. The data center or the control center can send requests to obtain E/P cycle status of memory devices in each of the plurality of memory systems. In response to receiving a request to obtain E/P cycle status, a memory system can determine Esum corresponding to one or more memory pages, and determine E/P cycle status based on the Esum. In some implementations, the central server or the control center can close down memory systems that are in EOL state, or prioritize data storage in memory systems that are in BOL state, based on the obtained E/P cycle status of the plurality of memory systems.

In some implementations, 702 and 712 are optional. Without receiving a request to obtain E/P cycle status from a host, the memory controller can send one or more commands to obtain Esum corresponding to one or more memory pages in a target memory block, and determine the E/P cycle status of the target memory block. Based on the E/P cycle status of different memory blocks in the memory device, the memory controller can perform operations such as wear-leveling management, garbage collection, and data migration. For example, when writing new data, the memory controller can select a memory block in BOL state to write the new data. For another example, the memory controller can perform garbage collection on a memory block that has undergone more E/P cycles before performing garbage collection on a memory block that has undergone fewer E/P cycles.

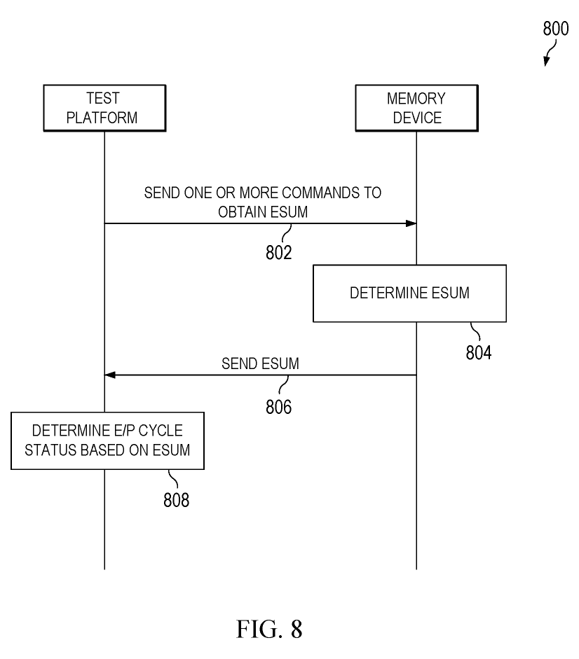

In some implementations, a memory device (e.g., a memory device under testing and verification, or a memory device during after-sale maintenance) can be connected to a test platform (e.g., a Magnum platform). As shown in process 800 of FIG. 8, the test platform can obtain E/P cycle status of the memory device based on Esum corresponding to memory pages in the memory device.

At 802, the test platform can send one more commands to the memory device to obtain Esum corresponding to one or more memory pages in a target memory block of the memory device. At 804, in response to receiving the one or commands from the test platform, the memory device performs sensing on memory cells in the one or more memory pages and obtains Esum corresponding to the one or more memory pages. At 806, the memory device sends Esum corresponding to the one or more memory pages to the test platform. At 808, the memory controller determines an E/P cycle status of the target memory block based on Esum corresponding to the one or more memory pages. In some implementations, by obtaining the E/P cycle status of all memory blocks in the memory device, the test platform can determine a maximum E/P cycle among the memory blocks in the memory device, a minimum E/P cycle among memory blocks in the memory device, and/or an average E/P cycle of memory blocks in the memory device.

The present disclosure also provides a non-transitory computer-readable storage medium. The non-transitory computer-readable storage medium stores one or more instructions (e.g., firmware of a memory controller) that are executable by a computer system. When being executed by the computer system, the instructions in the storage medium can implement method for determining E/P cycle status in a memory system as shown in FIGS. 1-8.

The non-transitory computer-readable storage medium can be an internal storage unit of the device described in any of the foregoing embodiments. For example, the non-transitory computer-readable storage medium can be a hard disk or an internal memory of the device. The non-transitory computer-readable storage medium can also be an external storage device of the device, such as a plug-in hard disk, a smart media card (SMC), a secure digital (SD) card, a flash card, etc. Further, the non-transitory computer-readable storage medium can also include an internal storage unit and an external storage device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A memory system, comprising:
a memory device comprising one or more memory pages; and
a memory controller coupled to the memory device, wherein the memory controller is configured to perform operations comprising:
obtaining a read window corresponding to the one or more memory pages; and
determining, based on the read window, an erase/program (E/P) cycle status of the one or more memory pages.

2. The memory system of claim 1, wherein obtaining the read window comprises:
sending one or more commands to obtain the read window to the memory device, wherein the one or more commands comprise an address of the one or more memory pages; and
obtaining the read window based on one or more responses to the one or more commands from the memory device.

3. The memory system of claim 1, wherein the E/P cycle status is determined based on a pre-determined relation between an E/P cycle and the read window, wherein the read window decreases with an increase of the E/P cycle.

4. The memory system of claim 3, wherein the pre-determined relation is stored in a buffer of the memory controller.

5. The memory system of claim 1, wherein the E/P cycle status comprises a ratio of a quantity of undergone E/P cycles of a first memory block to an expected maximum quantity of E/P cycles of the first memory block, wherein the first memory block comprises the one or more memory pages.

6. The memory system of claim 5, wherein the operations further comprise:
in response to determining that the ratio is larger than a threshold, moving data from the first memory block to a second memory block.

7. The memory system of claim 1, wherein the memory controller is configured to perform the operations in response to detecting a failure in the memory device.

8. The memory system of claim 1, wherein the memory controller is configured to perform the operations in response to receiving, from a host, a request to obtain health information of the memory device, and
wherein the operations further comprise sending the health information comprising the E/P cycle status to the host.

9. A memory controller, comprising one or more processors and an interface, wherein the memory controller is configured to:
send, through the interface to a memory device coupled to the memory controller, one or more commands to obtain a read window corresponding to one or more memory pages of the memory device; and
determine, by the one or more processors based on the read window, an erase/program (E/P) cycle status of the one or more memory pages.

10. The memory controller of claim 9, wherein the memory controller is configured to obtain the read window by receiving one or more responses to the one or commands from the memory device.

11. The memory controller of claim 9, wherein the E/P cycle status is determined based on a pre-determined relation between an E/P cycle and the read window, wherein the read window decreases with an increase of the E/P cycle.

12. The memory controller of claim 11, wherein the memory controller comprises a buffer, wherein the pre-determined relation is stored in the buffer.

13. The memory controller of claim 8, wherein the E/P cycle status comprises a ratio of a quantity of undergone E/P cycles of a first memory block to an expected maximum quantity of E/P cycles of the first memory block, wherein the first memory block comprises the one or more memory pages.

14. The memory controller of claim 13, wherein the memory controller is configured to:
in response to determining that the ratio is larger than a threshold, move data from the first memory block to a second memory block.

15. The memory controller of claim 9, wherein the memory controller is configured to determine the E/P cycle status in response to detecting a failure in the memory device.

16. The memory controller of claim 9, wherein the memory controller is configured to: determine the E/P cycle status in response to receiving, from a host, a request to obtain health information of the memory device; and
send the health information comprising the E/P cycle status to the host.

17. A method of operating a memory system, comprising:
obtaining a read window corresponding to one or more memory pages of a memory device of the memory system; and
determining, based on the read window, an erase/program (E/P) cycle status of the one or more memory pages.

18. The method of claim 17, comprising:
sending one or more commands to obtain the read window to the memory device, wherein the one or more commands comprise an address of the one or more memory pages; and
obtaining the read window based on one or more responses to the one or more commands from the memory device.

19. The method of claim 17, wherein the E/P cycle status is determined based on a pre-determined relation between an E/P cycle and the read window, wherein the read window decreases with an increase of the E/P cycle.

20. The method of claim 17, wherein the E/P cycle status comprises a ratio of a quantity of undergone E/P cycles of a first memory block to an expected maximum quantity of E/P cycles of the first memory block, wherein the first memory block comprises the one or more memory pages.
